(19) United States
(12) Patent Application Publication
(10) Pub. No.: US 2024/0092219 A1
(43) Pub. Date: Mar. 21, 2024

(54) ELECTRIC VEHICLE CHARGING STATE CONTROL SYSTEM AND CHARGING STATE CONTROL METHOD THEREFOR

(71) Applicants: HYUNDAI MOTOR COMPANY, Seoul (KR); KIA CORPORATION, Seoul (KR)

(72) Inventor: Hye Joo Lee, Bucheon-si (KR)

(73) Assignees: HYUNDAI MOTOR COMPANY, Seoul (KR); KIA CORPORATION, Seoul (KR)

(21) Appl. No.: 18/236,782

(22) Filed: Aug. 22, 2023

(30) Foreign Application Priority Data
Sep. 19, 2022 (KR) 10-2022-0117847

(51) Int. Cl. B60L 58/12; B60L 58/24

(52) U.S. Cl. CPC B60L 58/12; B60L 58/24; B60L 2240/70

(57) ABSTRACT

An electric vehicle charging state control method includes: requesting, by a first user, sharing of rental information using a first smart device; when the request for sharing the rental information is accepted, setting a to-be-shared external device by selecting at least one external device driven with power of a battery for driving an electric motor; sharing the set to-be-shared external device; when the to-be-shared external device is satisfied, matching the to-be-shared external device to a preset load power database (DB) and calculating estimated power amount information of the to-be-shared external device based on a matched result value obtained by the matching; and providing the calculated estimated power amount information to the first smart device.

### CROSS-REFERENCE TO RELATED APPLICATION

This application claims the benefit of and priority to Korean Patent Application No. 10-2022-0117847, filed on Sep. 19, 2022, the entire contents of which are incorporated herein by reference.

### TECHNICAL FIELD

The present disclosure relates to a system and method capable of calculating in advance a power consumption amount of an external device to be driven with the power of a battery for driving an electric motor and predicting the time at which the minimum charge amount (i.e., the discharging limit) of the battery is reached.

### BACKGROUND

As electric vehicles have become widely used, various functions using batteries or characteristics of electric vehicles are being developed and installed in the vehicles.

Such functions include, for example, a utility mode, a vehicle-to-load (V2L) mode, a vehicle-to-grid (V2G)/vehicle-to-home (V2H) mode, or the like.

The utility mode may refer to a function mode in which electronic devices (e.g., a multimedia player, an air conditioner, etc.) of the electric vehicle are used while the electric vehicle is at rest. The V2L mode may refer to a function mode in which a high-voltage battery of the electric vehicle is used as a power source for an external electric device. The V2G/V2H mode may refer to a function mode in which electric power is exchanged between the vehicle and an external infrastructure such as the grid or a home.

The amount of battery power for electric vehicles has increased with the introduction of constant-speed batteries and the like and there are a growing number of users who enjoy camping using electric vehicles. For example, users may camp by installing a tent around an electric vehicle or connecting the electric vehicle and the tent. As another example, users may camp by staying inside an electric vehicle.

Electric vehicles typically display a discharge amount (kW) in real time with the introduction of V2L. However, when an external electric device is used, it may be difficult to estimate how much of a real-time discharge amount is available to use or how it affects a battery.

In addition, electric vehicles provide settings of a minimum charge amount and the minimum charge amount may thus be set in an electric vehicle. However, it may not be easy to intuitively check a consumption amount of an external electric device during camping.

### SUMMARY

Various aspects of the present disclosure are directed to providing an electric vehicle charging state control system and a charging state control method therefor. In a case of determining the actual power consumption of an electric vehicle when a user is intended to go camping by renting or purchasing camping equipment in consideration of power characteristics of the electric vehicle, the system and method allow users and/or renters to readily share simulation setting information and increase simulation usability.

Also, various aspects of the present disclosure are directed to providing an electric vehicle charging state control system and a charging state control method therefor that effectively increase the usability of external electric devices using a battery of an electric vehicle using camping or other power. The system and method calculate an estimated vehicle-to-load (V2L) consumption amount based on a general consumption amount and an actual power consumption amount of the external electric devices frequently used by users for electronic parts (e.g., air conditioners, heaters, multimedia players, etc.) and V2L (indoor/outdoor) and predict an estimated time to reach a minimum charge amount based on the calculated values.

The aspects of the present disclosure are not limited to those described above. Other aspects not mentioned above should be clearly understood by those having ordinary skill in the art from the following description.

According to an embodiment of the present disclosure, a method is provided of simulating power consumption of an external device to be electrically connected to an electric vehicle. The method includes receiving a request for sharing rental information from a first device. The method also includes receiving information on at least one to-be-shared external device from a second device. The at least one to-be-shared external device may be selected through the second device in response to the request. The method further includes matching the information on the at least one to-be-shared external device to data of a preset load power database (DB). The method additionally includes obtaining estimated power amount information of the at least one to-be-shared external device based on a matched result of the matching. The method further includes providing the estimated power amount information to the first device.

According to another embodiment of the present disclosure, a system is provided for simulating power consumption of an external device to be electrically connected to an electric vehicle. The system includes a load power database (DB). The system also includes a server comprising at least one processor and a non-transitory computer-readable storage medium storing computer-readable instructions that, when executed by the at least one processor, cause the at least one processor to perform operations for simulating power consumption. The operations include receiving a request for sharing rental information from a first device. The operations also include receiving information on at least one to-be-shared external device from a second device. The at least one to-be-shared external device may be selected through the second device in response to the request. The operations further include matching the information on the at least one to-be-shared external device to data of a preset load power database (DB). The operations additionally include obtaining estimated power amount information of the at least one to-be-shared external device based on a matched result of the matching and providing the estimated power amount information to the first device

In at least one embodiment, the information on at least one to-be-shared external device is based on usage information of the at least one to-be-shared external device.

In at least one embodiment, obtaining the estimated power amount information comprises extracting a power consumption characteristic value according to a type of the electric vehicle.

In at least one embodiment, obtaining the estimated power amount information further includes obtaining a current external temperature of the electric vehicle and determining a temperature factor by matching the current external temperature to a preset temperature range.

In at least one embodiment, obtaining the estimated power amount information further includes obtaining a current state of charge (SOC) of a battery of the electric vehicle by applying at least one of the power consumption characteristic value or the temperature factor to power of the battery. Obtaining the estimated power amount also includes obtaining an available power amount remaining until a minimum charge amount of the electric vehicle based on the current SOC of the battery.

In at least one embodiment, the usage information includes basic power consumption information and a scheduled duration of time for use.

In at least one embodiment, obtaining the estimated power amount information further includes predicting an estimated time to reach the minimum charge amount.

In at least one embodiment, predicting the estimated time further includes predicting an estimated SOC of the battery.

In at least one embodiment, the method or operations further include adding data of a new device to the preset load power DB and recalculating estimated power amount information of the new device and the at least one to-be-shared external device.

In at least one embodiment, adding data of the new device includes receiving information on the new device from a server.

The electric vehicle charging state control system and the charging state control method therefor configured according to at least one embodiment of the present disclosure may allow a user to conveniently bring and use simulation settings in a situation where the user desires to perform a simulation.

In addition, the electric vehicle charging state control system and the charging state control method therefor configured according to at least one embodiment of the present disclosure may allow a user to record and share simulation settings set by the user.

In addition, the electric vehicle charging state control system and the charging state control method therefor configured according to at least one embodiment of the present disclosure may provide a result of predicting a situation of using rented items provided by a rental company or personally rented items in an environment of a vehicle of the user.

In addition, the electric vehicle charging state control system and the charging state control method therefor configured according to at least one embodiment of the present disclosure may increase the convenience of using V2L in an electric vehicle and reduce anxiety about power consumption caused while using a battery of the electric vehicle.

Additional advantages, objects, and features of the present disclosure are set forth in part in the following description and in part should become apparent to those having ordinary skill in the art from the following description or may be learned from practice of the disclosure. The objects and other advantages of the disclosure may be realized and attained by the structures particularly pointed out in the written description and the appended claims as well as the accompanying drawings.

### BRIEF DESCRIPTION OF THE DRAWINGS

FIG. 1 is a block diagram illustrating an electric vehicle charging state control system, according to an embodiment of the present disclosure.

FIG. 2 is a block diagram illustrating an example configuration of an electric vehicle, according to an embodiment of the present disclosure.

FIG. 3 is a block diagram illustrating an example configuration of a head unit, according to an embodiment of the present disclosure.

FIG. 4A and FIG. 4B are diagrams illustrating an example displayed on a display of a head unit, according to an embodiment of the present disclosure.

FIG. 5 is a diagram illustrating an electric vehicle charging state control method, according to an embodiment of the present disclosure.

FIG. 6 is a diagram illustrating an electric vehicle charging state control method, according to another embodiment of the present disclosure.

### DETAILED DESCRIPTION

Hereinafter, embodiments of the present disclosure are described in detail with reference to the accompanying drawings so that the embodiments may be readily implemented by those having ordinary skill in the art to which the present disclosure pertains. However, the present disclosure may be implemented in many different forms and is not limited to the embodiments described herein. In addition, to clearly explain the present disclosure with reference to the accompanying drawings, parts irrelevant to the description have been omitted, and similar reference numerals are used to designate similar parts throughout the specification.

In the present specification, it should be understood that a term such as “include” or “have” is intended to signify that the features, numbers, steps, operations, elements, parts, or combinations thereof described in the specification are present, and does not preclude the possibility of addition or presence of one or more other features, numbers, steps, operations, elements, parts, or combinations thereof.

When a component, device, element, or the like of the present disclosure is described as having a purpose or performing an operation, function, or the like, the component, device, or element should be considered herein as being “configured to” meet that purpose or perform that operation or function.

According to embodiments of the present disclosure, an electric vehicle charging state control system and method are provided. To determine an actual power usage of an electric vehicle when a user desires to go camping by renting or purchasing camping equipment in consideration of power characteristics of the electric vehicle, allows the user and/or rental company to readily share simulation setting information with each other and increases the usability of a simulation.

In addition, according to embodiments of the present disclosure, an electric vehicle charging state control system and method are provided that calculate an estimated amount of vehicle-to-load (V2L) consumption based on a general consumption amount and an actual power consumption amount of external electric devices frequently used by users for electronic parts (e.g., air conditioners, heaters, multimedia players, etc.) and V2L (indoor/outdoor) and accurately predict an estimated time to reach a minimum charge amount based on the estimated value.

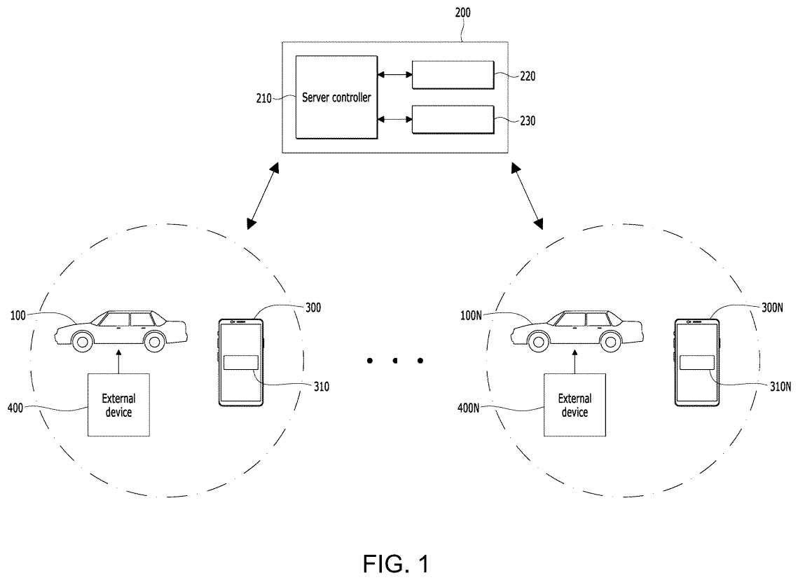

FIG. 1 is a block diagram illustrating an electric vehicle charging state control system, according to an embodiment of the present disclosure.

Referring to FIG. 1, an electric vehicle charging state control system may be a system for simulating power consumption of an external device to be electrically connected to an electric vehicle 100. The system may include a server 200, a plurality of electric vehicles (e.g., electric vehicles 100 to 100N), and a plurality of smart devices (e.g., smart devices 300 and 300N).

The smart devices may include a first smart device 300 to an nth smart device 300N. The smart devices may include, for example, one or more of a smart terminal, a smartphone, a portable terminal, a mobile phone, a portable device, or the like.

The first smart device 300 may request sharing of various camping-related information from the nth smart device 300N or a camping rental server through an application 310 or may receive the requested information. For example, the first smart device 300 may request sharing of rental information of at least one external device 400 and receive the requested rental information.

The first smart device 300 may be a device used by a first user. The first smart device 300 may be electrically connected to a first electric vehicle. For example, the first smart device 300 may be electrically connected to the first electric vehicle to share or synchronize various information.

Upon receiving the request for the rental information, the nth smart device 300N or the camping rental server may select at least one external device 400N, set a to-be-shared external device based on the selected external device 400N, and share the set to-be-shared external device. The nth smart device 300N may be a device used by an nth user. The nth smart device 300N may be electrically connected to an nth electric vehicle 100N.

The nth smart device 300N or the camping rental server may analyze the rental information based on previously measured usage information of a using device and may provide the first smart device 300 with information associated with analyzed result values, such as, a power consumption amount, an estimated time, or the like. As used herein, a using device may refer to a device to be used. The rental information may refer to various types of information associated with camping. Example rental information, according to some embodiments, is described in detail below.

The nth smart device 300N may also provide or receive various information or data to or from the server 200 through a wireless network. For example, the nth smart device 300N may receive available power amount information from the server 200 and may provide usage information of at least one using device selected by a user from among the at least one external device 400 to the server 200.

The nth smart device 300N may include at least one application 310N. The at least one application 310N may include an application 310N relating to the nth electric vehicle 100N. The application 310N may receive and display various information on the nth electric vehicle 100N through the server 200. Additionally or alternatively, the application 310N may set a command or default for remotely controlling the nth electric vehicle 100N.

The nth electric vehicle 100N may include a battery for driving an electric motor. The nth electric vehicle 100N may be a vehicle driven by the nth user.

When driving the at least one external device 400N with power of the battery, the nth electric vehicle 100N may analyze the power of the battery. The nth electric vehicle 100N may transmit available power amount information indicating an analyzed result value, obtained by the analysis of the power of the battery, to the server 200 using a wireless network or the like.

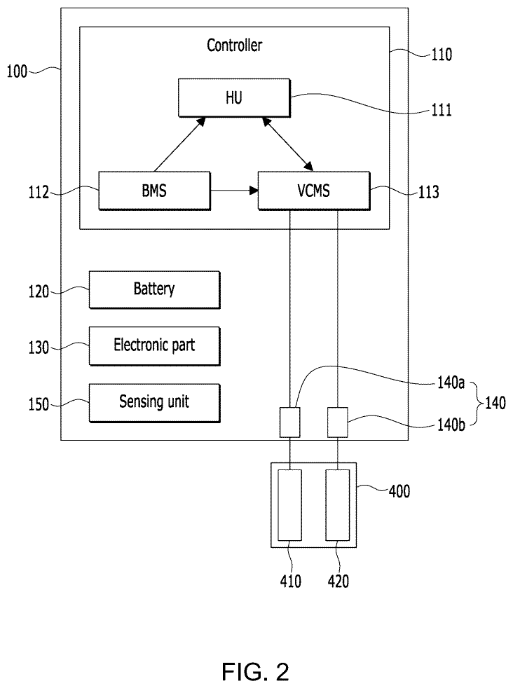

The battery (e.g., a battery 120 in FIG. 2) may be a high-voltage battery. When a mode is switched from a normal mode or a utility mode to a vehicle to load (V2L) mode, the power of the battery 120 may be a current state of charge (SOC) of the nth electric vehicle 100N.

The external device 400N may also be referred to herein as an external electric device or an external electronic device. The external device 400N may include any electric device that is electrically connected to the high-voltage battery 120 through indoor/outdoor connectors (e.g., 140a and 140b) of the nth electric vehicle 100N and that uses the high-voltage battery 120. The external device 400 may include, for example, an electric blanket, a small light bulb, a lantern, an induction stove, a mini oven, an electric kettle, an electric grill, a mini refrigerator, a wine cellar, or the like.

When the mode is determined to be the V2L mode, not the normal mode, the nth electric vehicle 100N may analyze the current SOC and may generate the available power amount information to include the analyzed result value. The available power amount information may indicate an available power amount remaining to a minimum charge amount based on the current SOC. The available power amount may also be referred to as an available power amount value.

The server 200 may collect the available power amount information from the nth electric vehicle 100N through a wireless network or the like. The server 200 may compare and analyze the collected available power amount information to specification data to calculate power consumption data and store the calculated power consumption data. The server 200 may also be referred to herein as a connected car service (CCS) server 200 or an external server 200. The available power amount information may also be referred to herein as power usage data. The specification data may include power consumption data displayed on the external device 400N. The specification data may include power consumption data indicated in product specifications. A load power database (DB) may store a plurality of pieces of specification data. The stored pieces of power usage data may be updated in some cases.

When the to-be-shared external device shared through the nth smart device 300N is satisfied by the first user, the server 200 may match the to-be-shared external device to the preset load power DB. The server 200 may calculate estimated power amount information of the to-be-shared external device based on a matched result value obtained by the matching. The server 200 may provide the calculated estimated power amount information to the first smart device 300.

The server 200 may include a server controller 210, a communication module 220, and a storage unit 230.

The server controller 210 may control various programs or devices for operations of the server 200. In an example, the server controller 210 may be configured to match usage information provided from the nth smart device 300N to the preset load power DB. The server controller 210 may also be configured to calculate estimated power amount information of a using device using the matched usage information and the available power amount information.

The server controller 210 may be configured to predict an estimated SOC of the battery 120 along with an estimated time. The server controller 210 may convert the calculated estimated power amount information of the using device to a SOC. In this case, the estimated power amount information on an amount of power to be consumed by the using device may be a value converted to the SOC.

As described above, the server controller 210 may calculate an estimated power consumption per hour based on a power usage DB of the external device 400N, which may be a general electric device. The power usage DB may also be referred to herein as the load power DB.

In addition, the server controller 210 may be configured to add information or data on recodes of usage of power (time/power amount/name of electric device/image, etc.) used by the corresponding electric vehicle 100 to an actually used DB. For example, the power usage DB or the load power DB may be used to update data on the records of usage of power (e.g., time/power amount/name of electric device/image, etc.) used by a user.

In an example, the server controller 210 may calculate the estimated power consumption amount, which is an estimated amount of power consumption, based on i) the power usage data actually measured after at least one use in the electric vehicle 100 and ii) the specification data.

In addition, the server controller 210 may analyze the estimated power amount information of a using device based on the matched usage information and the available power amount information and may predict an estimated time to reach a minimum charge amount based on the analyzed result value.

The server controller 210 may determine a remaining time until the minimum charge amount based on the estimated time. The server controller 210 may transmit the determined remaining time to the nth smart device 300N via the communication module 220. The server controller 210 may also transmit a notification signal to the nth smart device 300N before the estimated time is reached.

As described in more detail below, the server controller 210 may be configured to reset the minimum charge amount before the estimated time is reached=.

The server controller 210 may be electrically connected to the at least one smart device 300 or the camping rental server through the communication module 220. As described in more detail below, the server controller 210 may request various pieces of sharing information (e.g., a sharing request or a sharing request signal) from the at least one smart device 300 or the camping rental server and may provide the requested various pieces of sharing information.

The server controller 210 may comprise at least one processor and a non-transitory computer-readable storage medium or media storing computer-readable instructions for performing the functionalities as described above when executed by the at least one processor.

The communication module 220 may receive the available power amount information from the nth electric vehicle 100N. The communication module 220 may also receive the available power amount information or the calculated estimated power amount information from the nth smart device 300N or the camping rental server (e.g., a camping rental server 500) or provide the first smart device 300 with the estimated power amount information of the to-be-shared external device.

The communication module 220 may also be referred to herein as a wireless communication module 220. The wireless communication module 220 may provide a wireless communication function using a radio frequency. The wireless communication module 220 may include a network interface or modem for connection to a network (e.g., Internet, local area network (LAN), wide-area network (WAN), telecommunication network, cellular network, satellite network, plain old telephone service (POTS), or fifth generation (5G) network, etc.).

The storage unit 230 may store various programs and data required for operations of the server 200. The storage unit 230 may be implemented as a non-volatile storage unit, a volatile storage unit, a flash storage unit (e.g., flash memory), a hard disk drive (HDD), or a solid-state drive (SSD), or the like. The storage unit 230 may be accessed by the server controller 210, and data reading, writing, editing, deleting, and/or updating may be performed by the server controller 210.

In addition, the storage unit 230 may store the power usage data including an actual power consumption amount actually used by the nth electric vehicle 100 and the specification data including the power usage amount displayed on the external device 400, separately. For example, the storage unit 230 may classify the load power DB for storing the power consumption data and the specification DB for storing the specification data, and store the DBs separately.

The load power DB may record power usage (e.g., time/power amount/name of electric device/image, etc.) of the nth electric vehicle 100 of the nth user. The specification DB may store power usage of the external device 400, such as, for example, electric blanket 55 W, small light bulb 7 W, lantern 5 W, induction 75 W, mini oven 95 W, electric pot 30 W, electric grill 70 W, mini refrigerator 60 W, wine cellar 30 W, or the like.

The server controller 210 may be configured to substitute an actual power usage value of an external device based on actual power usage recorded or stored in the load power DB.

In addition, for a new external device that has never been used, the load power DB may store a product specification information value of the new external device under the control of the server controller 210. For example, the server controller 210 may control the communication module 220 to access a home page or server of the new external device and to receive product specification information on the new external device therefrom. However, examples are not limited thereto, and the server controller 210 may receive the product specification information value of the new external device in various ways.

FIG. 2 is a block diagram illustrating an example configuration of an electric vehicle, according to an embodiment of the present disclosure.

Referring to FIG. 2, an nth electric vehicle 100N according to an embodiment may include a battery 120, a sensing unit 150, and a controller 110. Hereinafter, the nth electric vehicle 100N is described as corresponding to the electric vehicle 100.

The battery 120 may store electrical energy required for driving the electric vehicle 100 and supply it during driving. The battery 120 may be a high-voltage battery.

The sensing unit 150 may include at least one temperature sensor. At least one temperature sensor may be disposed outside the electric vehicle 100 to sense an external temperature or outdoor temperature of the electric vehicle 100 in real time and provide the sensed external temperature or outdoor temperature to the controller 110.

The controller 110 may include a head unit 111, a battery management system (BMS) 112, and a vehicle charging management system (VCMS) 113. However, examples are not limited thereto, and the components shown in FIG. 2 may be mainly components relating to the embodiments of the present disclosure. For actual implementation, it should be apparent to those having ordinary skill in the art that the electric vehicle 100 may further include an electric motor and the controller 100 may further include a controller (e.g., a motor controller) for individually controlling the electric motor.

The BMS 112 may also be referred to as a battery controller. The VCMS 113 may also be referred to as a charge controller.

The head unit 111 may be configured to transmit, to the server 200, information on usage records of an external device 400 actually used in the electric vehicle 100.

The head unit 111 may provide real-time power usage display and minimum charge amount settings. The head unit 111 may be configured to request a notification from the smart device 300, for example 30 minutes before an estimated time to reach the minimum charge amount.

The BMS 112 may measure an amount of power consumed by an electronic part 130 installed in the electric vehicle 100 and may provide information on the measured amount of power to the head unit 111. In various examples, the electronic part 130 may include a multimedia player, an air conditioner, indoor mood lighting parts, or the like provided in the electric vehicle 100.

The BMS 112 may be electrically connected to the battery 120 and may provide information on the battery 120 of the electric vehicle 100 to the head unit 111. The information on the battery 120 of the electric vehicle 100 may include a current charge amount, a capacity state, a current SOC, or the like, of the battery 120.

When the battery 120 to be measured reaches the minimum charge amount, the BMS 112 may provide or request a block signal for blocking power transmission to the external device 400 to or from the VCMS 113.

In addition, the BMS 112 may predict an estimated required time to reach the minimum charge amount based on a real-time discharge amount (kW).

The VCMS 113 may be electrically connected to the external device 400. The VCMS 113 may be configured to measure a power usage or consumption amount of the external device 400 and to provide the measured power consumption amount to the head unit 111. In an example, the VCMS 113 may manage all charging-related functions in the electric vehicle 100 and may control to implement V2L together with an integrated charging control unit (ICCU).

In addition, the VCMS 113 may suspend a V2L mode when the block signal is provided from the BMS 112. For example, when the block signal is detected, the VCMS 113 may induce or control the V2L mode to be switched to a normal mode. However, examples are not limited thereto. In some cases, the V2L mode may be forcibly switched to the normal mode.

The external device 400 may include a first external device 410 that is electrically connected to or disconnected from a first connector 140a of the electric vehicle 100. The external device 400 may also include a second external device 420 that is electrically connected to or disconnected from a second connector 140b of the electric vehicle 100. The first connector 140a may also be referred to as an indoor connector, and the second connector 140b may also be referred to as an outdoor connector. The first external device 410 may be an electric device with relatively small power consumption that is usable inside the electric vehicle 100, and the second external device 420 may an electric device with relatively large power consumption that is usable outside the electric vehicle 100. However, examples are not limited thereto.

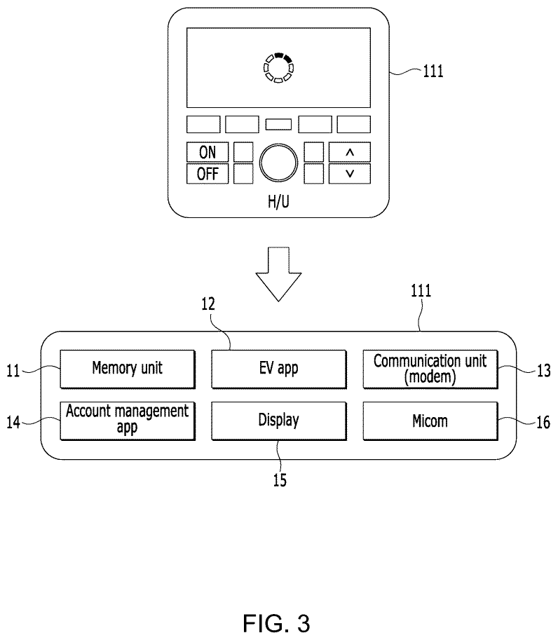

FIG. 3 is a block diagram illustrating an example configuration of a head unit, according to an embodiment of the present disclosure.

Referring to FIG. 3, the head unit 111 according to an embodiment may include a memory unit 11, an electric vehicle (EV) app 12, a communication unit 13, an account management app 14, a display 15, and a microcomputer (or micom) 16.

The memory unit 11 may record or store an amount of power used in the electric vehicle 100. The memory unit 11 may store a use start/end time, a power amount, and a connection type (indoor/outdoor/electronic parts) of all electric devices used in the electric vehicle 100.

The EV app 12 may set a minimum charge amount of the battery 120. In an example, the EV app 12 may set a V2L function to stop when the minimum charge amount is reached.

The communication unit 13 may transmit V2L usage information (or a power usage record) to the server 200. In a case of a V2L mode, the communication unit 13 may provide the server 200 with power consumption amount information on an amount of power to be transmitted to the external device 400 and available power amount information on an amount of available power set based on power of the battery 120. In an example, the communication unit 13 may provide the server 200 with information on an estimated time to reach the minimum charge amount based on information on the battery 120 and a real-time charge amount.

The account management app 14 may upload a user's account and terminal information on the smart device 300. The account management app 14 may manage the account to be linked on the server 200 or an app. In an example, the user's account may include XXX@Hyundai.com and the like.

The account management app 14 may control the head unit 11 to manage a power consumption amount of at least one external device 400 registered by the user. For example, the account management app 14 may control the head unit 11 o internally manage a current user value. The current user value may be the power consumption amount of the at least one external device 400 registered by the user.

The account management app 14 may be linked with an app (or phone app) installed on the server 200 or the smart device 300 to manage an actual use value of the user in a customized manner. The actual use value of the user may be an actual power consumption amount that is substantially measured for a predetermined period of time from the external device 400 that has been used while being connected to an indoor/outdoor connector of the electric vehicle 100.

The display 15 may display the EV app 12 and the account management app 14 on a screen. The display 15 may also display various information associated with the electric vehicle 100.

The micom 16 may transmit/receive actual controller area network (CAN) signals to/from the BMS/VCMS 112/113 of the electric vehicle 100. The micom 16 may transmit a user change value and may receive various data on the electric vehicle 100 in real time. The micom 16 may transmit the data to the EV app 12 or the like. In an example, the user change value may be a reset minimum charge amount.

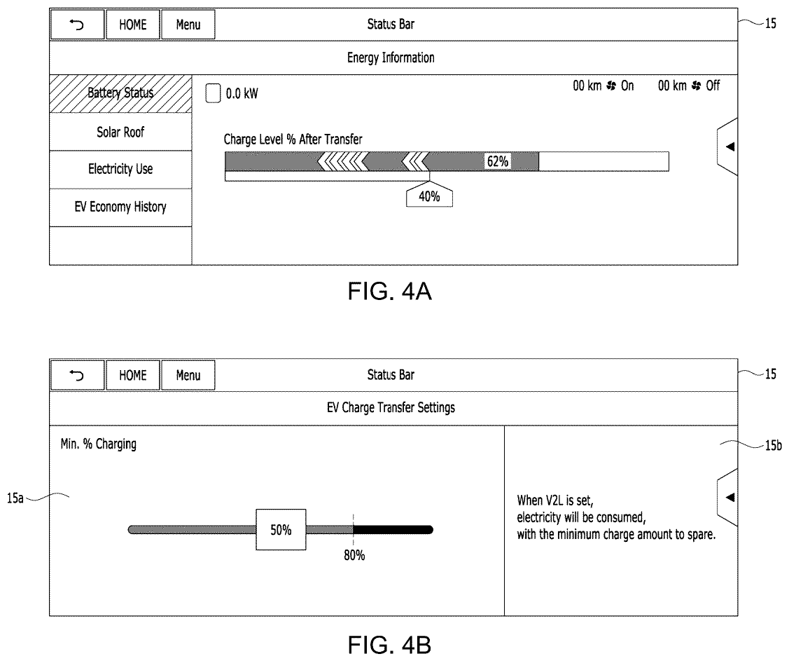

FIG. 4A and FIG. 4B, are diagrams illustrating an example displayed on a display of a head unit, according to an embodiment of the present disclosure.

Referring to FIG. 4A, the display 15 of the head unit 111 may display energy information of the electric vehicle 100. The display 15 of the head unit 111 may display a battery state of the electric vehicle 100 in the form of a bar. For example, the display 15 of the head unit 111 may display a case where a normal mode is switched to a V2L mode in the form of a bar.

Referring to FIG. 4B, when the mode is switched to the V2L mode, the display 15 of the head unit 111 may display settings for a current SOC and a minimum charge amount in a predetermined form or display a message related thereto. The predetermined form may be, for example, a bar, a graph, or the like. For example, as shown in FIG. 4B, the display 15 of the head unit 111 may include a first screen 15a and a second screen 15b. On a first screen 15a, a single bar indicates that the current SOC is 80% and the minimum charge amount is set to 50%. On a second screen 15b, a description of the current SOC and the minimum charge amount according to a current mode state is displayed. For example, on the second screen 15b, a message, “When V2L is set, electricity will be consumed, with the minimum charge amount to spare,” may be displayed.

The controller 110, the head unit 111, the BMS 112, and the VCMS 113 each may comprise one or more processors (e.g., computer, microprocessor, CPU, ASIC, circuitry, logic circuits, etc.) which perform the functionalities described above by executing one or more computer programs stored in one or more non-transitory computer-readable medium. Also, the processors of the head unit 111, the BMS 112, and the VCMS 113 may be separately provided or integrated in one processor.

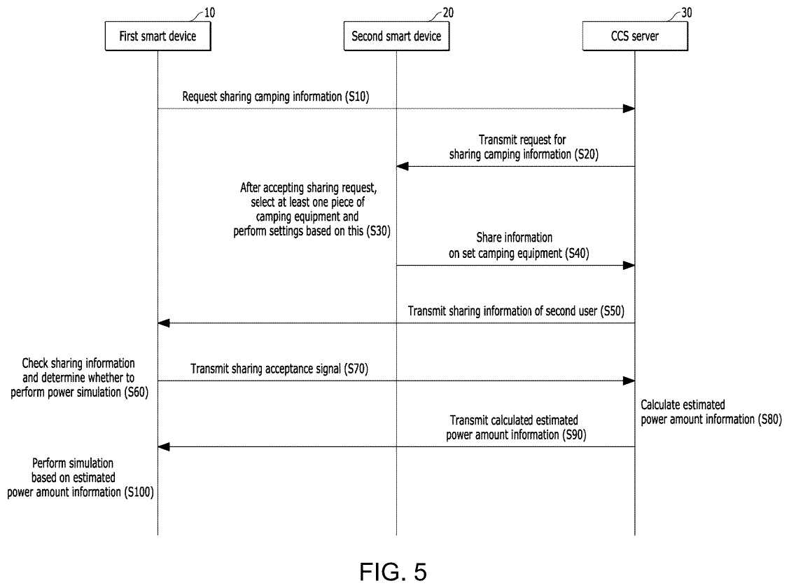

FIG. 5 is a diagram illustrating an electric vehicle charging state control method, according to an embodiment of the present disclosure.

An electric vehicle charging state control method, which is a method of controlling a charging state of an electric vehicle, according to an embodiment is described below with reference to FIG. 5.

In step or operation S10, a first user may request sharing of camping information of a second user through a CCS server 30, using a first smart device 10. The camping information may include information on camping simulation or power simulation. The first smart device 10 may transmit a sharing request signal that requests sharing of the camping simulation to the CCS server 30. The first user may request the CCS server 30 to provide the camping information on at least one piece of camping equipment among a plurality of pieces of camping equipment owned by the second user, using the first smart device 10. The first user may also be referred to herein as user 1. The second user may also be referred to herein as user 2.

In step or operation S20, the CCS server 30 may transmit the sharing request for the camping information of the second user to a second smart device 20. When the sharing request signal including the camping information is transmitted through the first smart device 10, the CCS server 30 may transmit or transfer the transmitted sharing request signal to the second smart device 20.

When the sharing request signal is transmitted to the second smart device 20, the second user may accept or reject the sharing request through the second smart device 20. For example, in step or operation S30, when accepting the sharing request, the second user may select at least one of the pieces of camping equipment (e.g., at least one external device) owned by the second user using the second smart device 20 and may configure settings based on the selected camping equipment. The selected camping equipment may be rentable camping equipment (at least one external device).

In step or operation S40, the second user may configure settings based on the selected camping equipment among the pieces of camping equipment (at least one external device) owned by the second user using the second smart device 20 and may share information on the set camping equipment.

The second user may select camping equipment to be shared (e.g., a to-be-shared external device) using the second smart device 20. The second user may provide settings based on the selected camping equipment (to-be-shared external device) and may share information on the set camping equipment (to-be-shared external device). The information on the set camping equipment (to-be-shared external device) may include power information on the camping equipment and various information associated with power usage of the camping equipment.

The second user may store various information or sharing information associated with the camping equipment (at least one external device) in the second smart device 20 or may transmit the information to the CCS server 30 through the second smart device 20. When new information on camping equipment (at least one external device) is obtained or updated, the second smart device 20 may synchronize the new information with the CCS server 30 in real time.

For example, the second user may select at least one using device from at least one external device that is owned by the second user or previously used at least once. The second smart device 20 may set a to-be-shared external device based on the selected at least one using device. The second smart device 20 may generate sharing information associated with the set to-be-shared external device and transmit the generated sharing information to the CCS server 30. The sharing information may include basic information on the selected using device and a scheduled use time of the selected using device.

In step or operation S50, when the sharing information requested from the second smart device 20 is transmitted, the CCS server 30 may transmit the sharing information to the first smart device 10. The first smart device 10 may thus receive the sharing information on the camping equipment (to-be-shared external device) set by the second user from the CCS server 30.

In step or operation S60, the first user may check the sharing information transmitted through the first smart device 10 and determine whether to proceed with the power simulation based on the checked sharing information. In step or operation S70, when it is determined that the power simulation is to be performed, the first smart device 10 may transmit a sharing acceptance signal to the CCS server 30.

In an example, when the sharing acceptance signal is not transmitted from the first smart device 10 for a predetermined period of time after the sharing information is transmitted to the first smart device 10, the CCS server 30 may determine that the first user disallows the sharing information and may provide related sharing disallowance information to the second smart device 20.

In step or operation S80, when the sharing acceptance signal is transmitted from the first smart device 10, the CCS server 30 may match the to-be-shared external device to a preset load power DB. The CCS server may then calculate estimated power amount information of the to-be-shared external device based on a matched result value obtained by the matching. The CCS server 30 may match the to-be-shared external device to the preset load power DB based on the transmitted information on the to-be-shared external device under the control of a server controller (not shown). The preset load power DB may store at least one external device and average power per hour of the external device. The load power DB may also be referred to as a power DB of an electric device.

The load power DB may store therein, for example, an electric camping blanket (average power of 14 W per hour), a small light bulb (average power of 7 W per hour), a lantern (average power of 75 W per hour), a portable induction (average power of 95 W per hour), a mini oven (average power of 30 W per hour), an electric kettle (average power of 70 W per hour), a mini refrigerator (average power of 60 W per hour), or the like.

In addition, the CCS server 30 may extract a power consumption characteristic value different for each type of electric vehicle and calculate estimated power amount information based on the extracted power consumption characteristic value. For example, when a vehicle model is Ioniq 5 of a constant speed type, the battery power consumption characteristic value is 76 kWh. In addition, the battery power consumption characteristic value for Ioniq 5 of a standard type is 64 kWh, for Kona EV is 48 kWh, for Niro EV is 48 kWh, for Ioniq EV is 32 kWh, and for Soul EV is 32 kWh. The forgoing consumption characteristic values are provided merely as examples, and the consumption characteristic value for each vehicle type is not limited to the foregoing examples.

In addition, the CCS server 30 may receive a current external temperature of a surrounding environment of the electric vehicle from the first smart device 10 or a first electric vehicle. The CCS server 30 may match the provided current external temperature to a preset temperature range to extract a temperature factor. The temperature factor may also be referred to herein as a temperature weight.

A current SOC of a battery may respond to an external ambient temperature, and the optimal performance of the battery may thus be slightly changed. Accordingly, the CCS server 30 may extract the temperature factor as different values corresponding to the preset temperature range under the control of the server controller. For example, the temperature factor may be extracted as 1.7 when the current external temperature sensed from outside the electric vehicle is between minus 10 degrees (−10°) and −5°, as 1.5 when between −5° and 0°, as 1.2 when between 0° and +10°, as 1.0 when between +10° and +20°, as 1.1 when between +20° and +30°, as 1.2 when between +30° and +35°, and as 1.3 when between +35° and +40°. The foregoing preset temperature range and temperature factors are provided merely as examples. The preset temperature range and the temperature factor are not limited to the foregoing examples.

The CCS server 30 may extract a different temperature factor for each preset temperature range based on the currently sensed external temperature under the control of the server controller. The CCS server 30 may apply the extracted temperature factor to calculate a current SOC of the battery with which the optimal performance of the battery may be achieved.

As described above, the CCS server 30 may apply at least one of the power consumption characteristic value or the temperature factor to the power of the battery under the control of the server controller to calculate the current SOC of the battery with which the optimal performance of the battery may be achieved. The CCS server 30 may thus accurately calculate or extract the estimated power amount information, i.e., information on an amount of power estimated to be left to reach the minimum charge amount of the electric vehicle.

The estimated power amount information may include at least one of the current SOC of the battery, an estimated power amount value, the power consumption characteristic value, or the temperature weight.

In step or operation S90, the CCS server 30 may transmit the calculated estimated power amount information to the first smart device 10. For example, the CCS server 30 may provide the calculated estimated power amount information to the first smart device 10 under the control of the server controller.

The first smart device 10 may display the estimated power amount information through an app. For example, the first smart device 10 may display information indicating that an estimated power consumption amount is 4.3 kW, an estimated battery SOC is 54%, and the minimum charge amount will be reached after using for 17 hours and 20 minutes or more, using the app. Therefore, it is possible to accurately provide the first user with estimated battery consumption information according to characteristics of a to-be-shared external device to be used through the first smart device 10.

In step or operation S100, the first user may perform the power simulation or camping simulation on the first electric vehicle based on the calculated estimated power amount information using the first smart device 10. The first smart device 10 may perform the power simulation on the first electric vehicle using the shared settings for the power simulation. Therefore, the second user may calculate a power result value that is substantially the same as that of the to-be-shared external device or a power result value within an error range.

However, examples are not limited to the foregoing. For example, the first user may additionally input, to the first electric vehicle (not shown), a device to be used and a time to use the device, in addition to the calculated estimated power amount information, using the first smart device 10. The first user may thus perform the power simulation by adding an item of the first user to the received sharing information of the second user.

In embodiments, as the first user adds an item of the first user to the to-be-shared external device shared by the second user in consideration of the characteristics of the first electric vehicle owned by the first user, it is possible to accurately and quickly predict result values of various simulations.

Although it is described above that the CCS server 30 applies at least one of the power consumption characteristic value or the temperature factor to the power of the battery under the control of the server controller, examples are not limited thereto. For example, the CCS server 30 may perform the matching to the load power DB under the control of the server controller and may transmit matching information obtained by the matching to the first smart device 10.

The first smart device 10 may provide or share the information on the load power DB provided to the CCS server 30 to or with the first electric vehicle through wireless communication or Bluetooth.

The first electric vehicle may apply at least one of the power consumption characteristic value or the temperature factor to the power of the battery based on the information on the load power DB and the sharing information under the control of a vehicle controller.

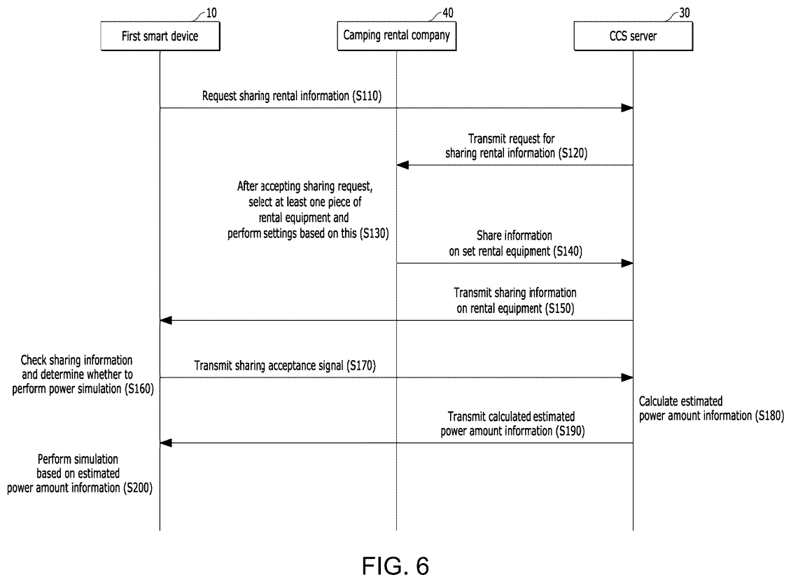

FIG. 6 is a diagram illustrating an electric vehicle charging state control method, according to another embodiment of the present disclosure.

An electric vehicle charging state control method, which is a method of controlling a charging state of an electric vehicle, according to another embodiment of the present disclosure is described below with reference to FIG. 6.

In step or operation S110, the first user may request sharing of rental information using the first smart device 10. The rental information may include information associated with renting for camping simulation. The first smart device 10 may transmit, to the CCS server 30, a request signal that requests a rental for the camping simulation. The first user may request rental information on at least one of a plurality of pieces of camping equipment owned by a camping rental company 40 by using the first smart device 10. In other words, the first user may request a server or site of the camping rental company 40 for the rental information for the camping simulation through the first smart device 10. The first user may also be referred to herein as user 1.

In step or operation S120, the CCS server 30 may notify the rental information sharing request. When a rental request signal including the rental information is transmitted through the first smart device 10, the CCS server 30 may transmit the transmitted rental request signal to the camping rental company 40.

In step or operation S130, when accepting the rental information requested to be shared, the camping rental company 40 may select rental equipment including at least one rentable external device and may configure settings based on the selected rental equipment (at least one external device). The selected rental equipment may be rental camping equipment.

The camping rental company 40 may select at least one rentable rental equipment from among a plurality of pieces of rental equipment (a plurality of external devices) and configure settings based on the selected rental equipment.

In step or operation S140, the camping rental company 40 may select at least one piece of information on the rentable rental equipment (at least one external device) and may allow sharing the information. The camping rental company 40 may select rentable rental equipment (e.g., a to-be-shared external device), configure settings on the selected rental equipment (to-be-shared external device), and share information on the set rental equipment. The information on the set rental equipment (to-be-shared external device) may include power information on the rental equipment.

The camping rental company 40 may store various information or shared information associated with the rental equipment (at least one external device) in the server of the camping rental company 40 or transmit the information to the CCS server 30 through wireless communication. When new information on the rental equipment (at least one external device) is obtained or updated, the camping rental company 40 may synchronize the new information with the CCS server 30 in real time.

In step or operation S150, when the requested sharing information on the rental equipment is transmitted from the camping rental company 40, the CCS server 30 may transmit the information to the first smart device 10. The first smart device 10 may thus receive, from the CCS server 30, the sharing information for power simulation of the rental equipment (to-be-shared external device) available for a rental from the camping rental company 40.

In step or operation S160, the first user may check the sharing information transmitted through the first smart device 10 and may determine whether to proceed with the power simulation based on the checked sharing information. In step or operation S170, when it is determined to proceed with the power simulation, the first user may transmit a sharing acceptance signal to the CCS server 30.

In step or operation S180, the CCS server 30 may match the shared rental equipment or the set rental equipment to a preset load power DB under the control of the server controller and may calculate estimated power amount information of the shared rental equipment based on a matched result value obtained by the matching. This has been sufficiently described above with reference to FIG. 5, and thus a more detailed and repeated description has been omitted.

In step or operation S190, the CCS server 30 may transmit the calculated estimated power amount information to the first smart device 10.

In step or operation S200, the first user may perform the power simulation or camping simulation on the first electric vehicle based on the calculated estimated power amount information using the first smart device 10. This has been sufficiently described above with reference to FIG. 5, and thus a more detailed and repeated description has been omitted.

In addition, the camping rental company 40 may generate at least one camping equipment set based on information on the first electric vehicle obtained from the first smart device 10.

The at least one camping equipment set may be selected in response to various camping environmental conditions based on rentable camping equipment (to-be-shared external equipment).

The camping rental company 40 may provide a camping guide to the first user by transmitting the selected camping equipment set to the first smart device 10.

The present disclosure described above may be embodied as computer-readable code on a medium in which a program is recorded. The computer-readable medium includes all types of recording devices in which data readable by a computer system is stored. Examples of the computer-readable medium include a hard disk drive (HDD), a solid-state drive (SSD), a silicon disk drive (SDD), a read-only memory (ROM), a random-access memory (RAM), a CD-ROM, a magnetic tape, a floppy disk, an optical data storage device, etc.

The above detailed description should not be construed as restrictive and should be considered as illustrative in all respects. The scope of the present disclosure should be determined by the appended claims. All modifications within the equivalent scope of the present disclosure are included in the scope of the present disclosure.

What is claimed is:

1. A method of simulating power consumption of an external device to be electrically connected to an electric vehicle, the method comprising:
receiving a request for sharing rental information from a first device;
receiving information on at least one to-be-shared external device from a second device, the at least one to-be-shared external device being selected through the second device in response to the request;
matching the information on the at least one to-be-shared external device to data of a preset load power database (DB);
obtaining estimated power amount information of the at least one to-be-shared external device based on a matched result of the matching; and
providing the estimated power amount information to the first device.

2. The method of claim 1, wherein the information on at least one to-be-shared external device is based on usage information of the at least one to-be-shared external device.

3. The method of claim 2, wherein obtaining the estimated power amount information comprises extracting a power consumption characteristic value according to a type of the electric vehicle.

4. The method of claim 3, wherein obtaining the estimated power amount information further comprises:
obtaining a current external temperature of the electric vehicle; and
determining a temperature factor by matching the current external temperature to a preset temperature range.

5. The method of claim 4, wherein obtaining the estimated power amount information further comprises:
obtaining a current state of charge (SOC) of a battery of the electric vehicle by applying at least one of the power consumption characteristic value or the temperature factor to power of the battery; and
obtaining an available power amount remaining until a minimum charge amount of the electric vehicle based on the current SOC of the battery.

6. The method of claim 5, wherein obtaining the estimated power amount information further comprises predicting an estimated time to reach the minimum charge amount.

7. The method of claim 6, wherein predicting the estimated time further comprises predicting an estimated SOC of the battery.

8. The method of claim 2, wherein the usage information includes basic power consumption information and a scheduled duration of time for use.

9. The method of claim 2, further comprising:
adding data of a new device to the preset load power DB; and
recalculating estimated power amount information of the new device and the at least one to-be-shared external device.

10. The method of claim 9, wherein adding data of the new device comprises receiving information on the new device from a server.

11. A system for simulating power consumption of an external device to be electrically connected to an electric vehicle, the system comprising:
a load power database (DB); and
a server comprising at least one processor and a non-transitory computer-readable storage medium storing instructions that, when executed by the at least one processor, cause the at least one processor to perform operations including
receiving a request for sharing rental information from a first device,
receiving information on at least one to-be-shared external device from a second device, the at least one to-be-shared external device being selected through the second device in response to the request,
matching the information on the at least one to-be-shared external device to data of a preset load power database (DB), and obtaining estimated power amount information of the at least one to-be-shared external device based on a matched result of the matching, and
providing the estimated power amount information to the first device.

12. The system of claim 11, wherein the information on at least one to-be-shared external device is based on usage information of the at least one to-be-shared external device.

13. The system of claim 12, wherein obtaining the estimated power amount information comprises extracting a power consumption characteristic value according to a type of the electric vehicle.

14. The system of claim 13, wherein obtaining the estimated power amount information further comprises:
obtaining a current external temperature of the electric vehicle; and
determining a temperature factor by matching the current external temperature to a preset temperature range.

15. The system of claim 14, wherein obtaining the estimated power amount information further comprises:
obtaining a current state of charge (SOC) of a battery of the electric vehicle by applying at least one of the power consumption characteristic value or the temperature factor to power of the battery; and
obtaining an available power amount remaining until a minimum charge amount of the electric vehicle based on the current SOC of the battery.

16. The system of claim 15, wherein obtaining the estimated power amount information further comprises predicting an estimated time to reach the minimum charge amount.

17. The system of claim 16, wherein predicting the estimated time further comprises predicting an estimated SOC of the battery.

18. The system of claim 12, wherein the usage information includes basic power consumption information and a scheduled duration of time for use.

19. The system of claim 12, wherein the operations further include:
adding data of a new device to the preset load power DB; and
recalculating estimated power amount information of the new device and the at least one to-be-shared external device.

20. A server comprising:
at least one processor; and
a non-transitory computer-readable storage medium storing instructions that, when executed by the at least one processor, cause the at least one processor to perform operations including
receiving a request for sharing rental information from a first device,
receiving information on at least one to-be-shared external device from a second device, the at least one to-be-shared external device being selected through the second device in response to the request,
matching the information on the at least one to-be-shared external device to data of a preset load power database (DB),
obtaining estimated power amount information of the at least one to-be-shared external device based on a matched result of the matching, and
providing the estimated power amount information to the first device.
